(19) United States
(12) Patent Application Publication
(10) Pub. No.: US 2006/0231552 A1
(43) Pub. Date: Oct. 19, 2006

(54) Microwave popcorn container and method of fabrication

(76) Inventor: Yves Caya, Longueuil (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/402,140

(22) Filed: Apr. 12, 2006

(30) Foreign Application Priority Data
Apr. 14, 2005 (CA) 2,504,254

(51) Int. Cl. H05B 6/80

(52) U.S. Cl. 219/727

(57) ABSTRACT

A microwave popcorn container and its method of fabrication is described. The container is constructed of two parts, a formable paperboard dish and a top flexible impermeable sheet capable of being deployed outwardly by the popcorn kernels when popped. The paperboard dish is formed with a bottom wall and a circumferential side wall having a circumferential flange. A heat susceptor is retained over the bottom wall and an impermeable sheet is laminated thereover and extends to a lower portion of the circumferential side wall. Popcorn kernels and a cooking liquid mixture is disposed over the impermeable sheet and it is then covered with a top flexible impermeable sheet disposed over the popcorn kernel and the side walls and is secured about the circumferential top flange.

### TECHNICAL FIELD

The present invention relates to a microwave popcorn container and its method of fabrication.

### BACKGROUND ART

There exists on the market a multitude of containers containing popcorn kernels and for use in microwaves. The most popular one of these containers is the bag container. This bag container is fabricated of treated paper or other flexible material which are often laminated with a heat susceptor that absorbs energy from the microwaves to heat itself sufficiently to cause the cooking liquid, which is mixed mix with the popcorn kernels, to melt and generate heat sufficient to cause the kerns to pop. These bags are fabricated in a folded state whereby not to occupy a large space. During the cooking cycle, the bag deploys itself by the expansion of the kernels which pop and occupy a larger space.

More rigid popcorn containers are also known. The majority of these known types have a conical basket shape that we often find in movie theaters. With this type of container, the heat susceptor is usually glued over the bottom wall of the container whereby to generate heat under the influence of microwaves. The susceptor is covered with popcorn kernels and an oil mixture which can contain spices, etc. A covering is then glued on the inner side walls of the basket and extends over the kernels. This extendable cover provides major problems, one being that it is not sufficiently hermetic and does not deploy itself properly because it is glued to the interior side walls of the basket. Many patents have addressed this problem and the following reference is made to U.S. Pat. Nos. 5,008,024, 5,097,107; 5,214,257, 5,834,046, 5,985,343, 6,126,976, 6,320,172 and 6,586,715.

Another disadvantage of these baskets is that they are expensive to produce and therefore are not very popular on the marketplace. They also occupy large spaces and cannot be used in distributing machines or on small shelf spaces. However, an advantage of the basket is that it serves as a container for the popcorn.

### SUMMARY OF INVENTION

It is a feature of the present invention to provide a microwave popcorn container and its method of fabrication which substantially overcomes the above-mentioned disadvantages of the prior art.

Another feature of the present invention is to provide a microwave popcorn container and its method of fabrication which is less costly to produce, which provides good hermetic sealing and which is of a configuration permitting it to be used in distributing machines as well as being easily packaged and occupying less shelf space.

According to the above features, from a broad aspect, the present invention provides a microwave popcorn container which comprises a formable paperboard dish having a flat bottom wall and an outwardly tapering circumferential side wall having a circumferential top retainer flange. A heat susceptor is retained over the inner surface of the bottom wall. An impermeable sheet is laminated over the heat susceptor and the bottom wall and extends over a lower portion of the circumferential side wall. A predetermined quantity of popcorn kernels and a cooking liquid mixture are disposed on the impermeable sheet. The cooking liquid mixture remains in solid state below a temperature of about 110° F. A top flexible impermeable sheet is disposed over the popcorn kernels on the bottom wall and extends over an inner surface of the circumferential side wall and is secured about the top retainer flange. The predetermined quantity of popcorn kernels is dependent on the volume defined between the bottom wall, the circumferential side wall and the top flexible impermeable sheet when deployed outwardly of the paperboard dish by popped kernels.

According to a further broad aspect of the present invention there is provided a method of fabricating a microwave popcorn container. The method comprises the steps of pressing a treated cardboard material in a mold to form a container dish having a flat bottom wall, an outwardly tapering circumferential side wall and a circumferential top retainer flange. A susceptor plate is secured over an inner face of the bottom wall and a bottom impermeable sheet is secured over the susceptor plate and at least partly over the circumferential side wall. A predetermined quantity of popcorn kernels and a cooking liquid mixture in dry form is positioned over the bottom impermeable sheet above the susceptor plate. A top flexible impermeable sheet is positioned over the popcorn kernels and cooking liquid mixture in dry form, and the circumferential side wall and the top retainer flange. This top flexible impermeable sheet is sealed to the top retainer flange.

### BRIEF DESCRIPTION OF DRAWINGS

A preferred embodiment of the present invention will now be described with reference to the accompanying drawings in which:

FIG. 1 is a perspective view of the microwave popcorn container fabricated in accordance with the present invention;

FIG. 2 is section view showing the position of the heat susceptor over the bottom wall of the formable paperboard dish;

FIG. 3A is a cross-section view similar to FIG. 2 illustrating the popcorn kernels and the cooking liquid mixture disposed over the impermeable sheet laminated over the susceptor;

FIG. 3B is an enlarged view of detail B of FIG. 3A;

FIG. 4A is an enlarged cross-section view, partly fragmented showing the top flexible impermeable sheet disposed over the popcorn kernels on the bottom wall;

FIG. 4B is an enlarged view of detail A of FIG. 4A; and

FIG. 5 is a section view showing the top flexible impermeable sheet when deployed outwardly of the paperboard dish by the popped kernels.

### DESCRIPTION OF PREFERRED EMBODIMENTS

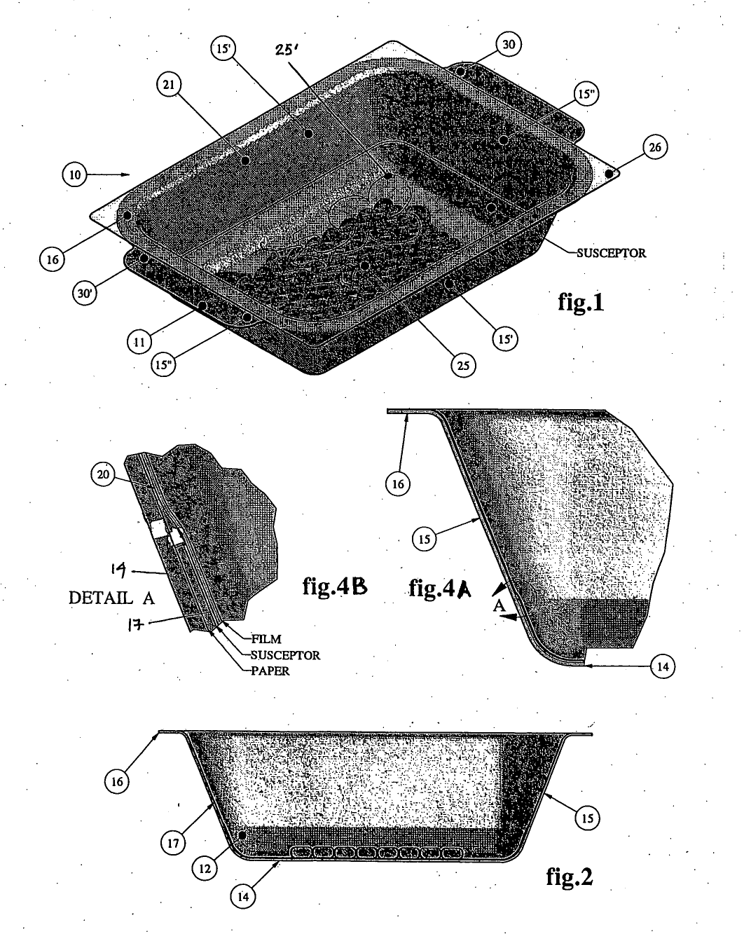

Referring now to the drawings, namely, FIGS. 1 to 5, there is shown the microwave popcorn container 10 of the present invention. This container is comprised of a formable paperboard dish 11 fabricated of cardboard material which is treated to be impermeable. A heat susceptor 12, well known in the art in the form of a sheet or plate, is of sufficient dimension to generate sufficient heat to pop the popcorn kernels 13 contained within the assembled container 10 and is retained over the bottom wall 14 of the paperboard dish.

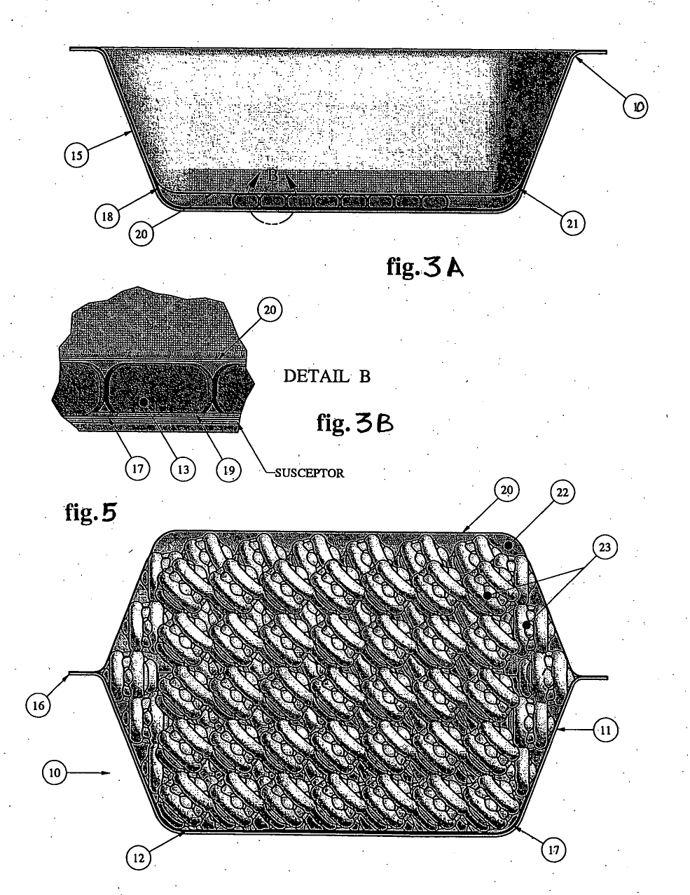

As is more clearly illustrated in FIGS. 2 and 3, the paperboard dish has a bottom wall 14 and an outwardly tapering circumferential side wall 15. As hereinshown, the dish has a substantially rectangular shape and defines opposed elongated side walls 15′ and end walls 15″. The side walls have a circumferential top retainer flange 16 thereabout and may be provided with end flange extensions to form handle grips 30 and 30′ at opposed ends. An impermeable sheet 17, see FIG. 2, is laminated over the heat susceptor 12 and the bottom wall 14 and extends over a lower portion 18 of the side wall 15.

As shown in FIG. 3, a predetermined quantity of popcorn kernels 13 and a solid cooking liquid mixture 19 are disposed on the impermeable sheet 17. The cooking liquid mixture remains in a solid state below a temperature of about 110° F.

As also shown in FIG. 3, a top flexible impermeable sheet 20 is disposed over the popcorn kernels on the bottom wall and extends over an inner face 21 of the circumferential side wall 15 and is secured about the top retainer flange 16. The sheet 20 could be glued to the retainer flange or fused thereto whereby to provide a substantially hermetic seal. As shown in FIG. 4, this flexible impermeable sheet 20 is pressed within the container over the bottom wall and side walls. Accordingly, when the sheet 20 is deployed, as shown in FIG. 5, there results a substantial volume 22 inside the container whereby to retain the popped corn 23. The predetermined quantity of kernels 13 which are positioned over the impermeable sheet 17 is dependent on the volume defined between the bottom wall 14 of the paperboard dish, its circumferential side wall 15 and the top flexible impermeable sheet extension when deployed outwardly of the paperboard dish by popped kernels, as shown in FIG. 5.

A preferred method of manufacturing this microwave popcorn container is by lamination. It is pointed out that the paperboard dish is of cardboard material which has sufficient humidity for lamination. The cardboard is pressed in a mold (not shown) and dried to keep its form, such as the form shown in FIG. 1. The cardboard material, the susceptor plate 12 and the bottom impermeable sheet 17 can be laminated together by heat pressing in a single step. It is not intended to limit the invention to this specific shape as it could also be a round container and it can be of different dimensions. The circumferential retainer flange 16 is dimensioned in order to obtain the hermetic seal as above mentioned. The side wall should also have a sufficient height to contain the popped corn together with the expanded flexible impermeable sheet. The conical side walls 15 also permit a plurality of these containers to be stacked one within another to form stacks for shipping purposes and for display purposes on shelves of retailers.

It is also pointed out that the heat susceptor disc or plate can be glued on the bottom wall, heat-pressed thereon or retained captive between the lower portion of the side walls of the dish. The impermeable sheet 20 also needs to be impermeable to the grease or oil mixture 19 disposed thereover and it needs to be larger than the bottom wall in order to fully protect the foodstuff, that is to say the kernel and its oil and spices, from the susceptor and also the lower portion 18 of the side wall 15. As also shown in FIG. 1, a cover disc or sheet 25 is secured to the top flexible impermeable sheet 20 and may contain advertising material 25′ on a top surface thereof. This cover may be glued thereto and it is also conceivable that printed material can be printed on the outer surface of this top flexible impermeable sheet 20. The cover can have the size of the bottom wall as hereinshown. After this impermeable sheet is glued to the paperboard dish retainer flange, it is heat pressed so that it assumes the shape as shown in FIG. 4. The final shape of this top flexible impermeable sheet must follow the contour of the inner surface of the side walls as well as the retainer flange. The microwave popcorn container of the present invention is inexpensive to fabricate and the manufacture thereof can be fully automated.

In order to permit the consumer ease of manipulation and finger gripping of the paperboard dish, particularly when in the microwave oven, a lip 26 may be formed in a corner portion of the container and this is done as an extension of the retainer flange 16. Handle grips 30 and 30′ may also be provided as previously described. For shipping purposes it is also preferable that a plurality of these microwave containers 10 be stacked one on top of the other and then placed in a bag or container which is hermetically sealed. Because these containers are easily stackable, they are convenient for use in distribution machines. Another advantage of these containers is that once the kernels have popped and the top sheet deployed there is automatically formed a popcorn container which is connected into a dish which is easy to handle by a user person.

It is within the ambit of the present invention to cover any obvious modifications of the preferred embodiment described herein, provided such modifications fall within the scope of the appended claims.

I claim:

1. A microwave popcorn container comprising a formable paperboard dish having a flat bottom wall, and an outwardly tapering circumferential side wall having a circumferential top retainer flange; a heat susceptor retained over an inner surface of said bottom wall, a bottom impermeable sheet laminated over said heat susceptor and said bottom wall and extending over a lower portion of said circumferential side wall, a predetermined quantity of popcorn kernels and a cooking liquid mixture disposed on said impermeable sheet, said cooking liquid mixture remaining in solid state below a temperature of about 110° F., a top flexible impermeable sheet disposed over said popcorn kernels on said bottom wall and extending over an inner face of said circumferential side wall and secured about said top retainer flange; said predetermined quantity of popcorn kernels being dependent on the volume defined between said bottom wall, said circumferential side wall and said top flexible impermeable sheet when deployed outwardly of said paperboard dish by popped kernels.

2. A microwave popcorn container as claimed in claim 1 wherein said dish is fabricated from cardboard material treated to be impermeable.

3. A microwave popcorn container as claimed in claim 1 wherein said top flexible impermeable sheet is glued on said top retainer flange to provide a substantially hermetic seal, said flexible impermeable sheet being pressed against said popcorn kernels and cooking liquid mixture and said circumferential side wall to provide maximum volume space when deployed.

4. A microwave popcorn-container as claimed in claim 1 wherein said top flexible impermeable sheet is fused to said top retainer flange to provide a substantially hermetic seal, said flexible impermeable sheet being pressed against said popcorn kernels and cooking liquid mixture and said circumferential side wall to provide maximum volume space when deployed.

5. A microwave popcorn container as claimed in claim 1 wherein said bottom impermeable sheet is impermeable to said cooking liquid mixture and extends to said top retainer flange.

6. A microwave popcorn container as claimed in claim 1 wherein a cover sheet is also secured over said top flexible impermeable sheet, and printed material disposed on a top surface of said cover sheet.

7. A microwave popcorn container as claimed in claim 1 wherein said top retainer flange defines flange extensions at opposed ends of said paperboard dish to form handle grips.

8. A microwave popcorn container as claimed in claim 1 wherein said top retainer flange forms a lip in a corner of said paperboard dish for finger gripping.

9. A method of fabricating a microwave popcorn container comprising the steps of:
i) pressing a treated cardboard material in a mold to form a container dish having a flat bottom wall, an outwardly tapering circumferential side wall and a circumferential top retainer flange,
ii) securing a susceptor plate over an inner face of said bottom wall,
iii) securing a bottom impermeable sheet over said susceptor plate and at least partly over said circumferential side wall,
iv) positioning a predetermined quantity of popcorn kernels and a cooking liquid mixture in dry form over said bottom impermeable sheet above said susceptor plate,
v) positioning a top flexible impermeable sheet over said popcorn kernels and cooking liquid mixture in dry form, and said circumferential side wall and said top retainer flange, and
vi) sealing said top flexible impermeable sheet to said top retainer flange.

10. A method as claimed in claim 9 wherein said steps i), ii) and iii) are effected in a single laminating step of heat pressing said treated cardboard material with said susceptor plate positioned thereon and said bottom impermeable sheet thereover, in said mold.

11. A method as claimed in claim 9 wherein said step ii) comprises gluing said susceptor plate over an inner face of said bottom wall.

12. A method as claimed in claim 9 wherein said step iii) comprises laminating said bottom impermeable sheet over said susceptor plate and said circumferential side wall.

13. A method as claimed in claim 9 wherein there is further provided the step of gluing a cover sheet containing printed material over said top flexible impermeable sheet, said cover sheet being dimensioned to cover said bottom wall to form a finished product popcorn container dish.

14. A method as claimed in claim 13 wherein there is further provided the step of stacking a plurality of said popcorn container dishes one within the other to form a stack for shipping or display.
